(19) United States
(12) Patent Application Publication
(10) Pub. No.: US 2011/0057132 A1
(43) Pub. Date: Mar. 10, 2011

(54) SOLENOID VALVE

(75) Inventors: Philip C. Lundberg, Keego Harbor, MI (US); Bret M. Olson, White Lake, MI (US)

(73) Assignee: GM GLOBAL TECHNOLOGY OPERATIONS, INC., Detroit, MI (US)

(21) Appl. No.: 12/555,924

(22) Filed: Sep. 9, 2009

(51) Int. Cl. F16K 31/02; H02K 41/035

(52) U.S. Cl. 251/129.15; 310/14

(57) ABSTRACT

A solenoid valve includes an armature portion, a spool portion, a housing, and a piloting feature that is operatively connected to the housing and configured to align and guide the armature portion. A stator is disposed with respect to the housing and has a selectively energizable coil disposed annularly about the armature portion. The stator is configured to selectively subject the armature portion to a stator force and the armature portion is linearly moveable within the stator. A return spring is configured to provide a return force generally opposite the stator force.

### TECHNICAL FIELD

This disclosure relates to solenoid valves for selectively varying fluid flow.

### BACKGROUND OF THE INVENTION

Solenoids are devices that convert electrical current into linear motion. A coil within the solenoid converts electrical energy into a magnetic field. The solenoid may therefore convert electrical energy into mechanical energy which moves a magnetically-responsive armature. The armature, in turn, mechanically moves the valve to shut off, release, dose, distribute, regulate, or mix fluids. Solenoid valves may directly control fluid systems flowing through the valve orifice or may be used to control flow through a larger orifice.

### SUMMARY

A solenoid valve includes an armature portion, a spool portion, and a housing. A piloting feature is operatively connected to the housing and configured to align and guide the armature portion. A stator is disposed with respect to the housing and has a selectively energizable coil disposed annularly about the armature portion. The stator is configured to selectively subject the armature portion to a stator force and the armature portion is linearly moveable within the stator. A return spring is configured to provide a return force generally opposite the stator force.

The stator of the solenoid valve may be configured such that the stator force pulls the armature portion toward the stator, and the return spring configured to push the armature portion away from the stator. The armature portion may include a first mating feature and the spool portion a second mating feature, such that the armature portion and the spool portion are separate components which are operatively connected by the first and second mating features.

The above features and advantages and other features and advantages of the present invention are readily apparent from the following detailed description of the best modes and other embodiments for carrying out the invention when taken in connection with the accompanying drawings.

### BRIEF DESCRIPTION OF THE DRAWINGS

FIG. 1 is a schematic, cross-sectional view of a pull-style solenoid valve;

FIG. 2 is a schematic, cross-sectional view of a pull-style solenoid valve having combined armature and spool portions; and

FIG. 3 is a schematic, cross-sectional view of a push-style solenoid valve having combined armature and spool portions.

### DESCRIPTION OF PREFERRED EMBODIMENTS

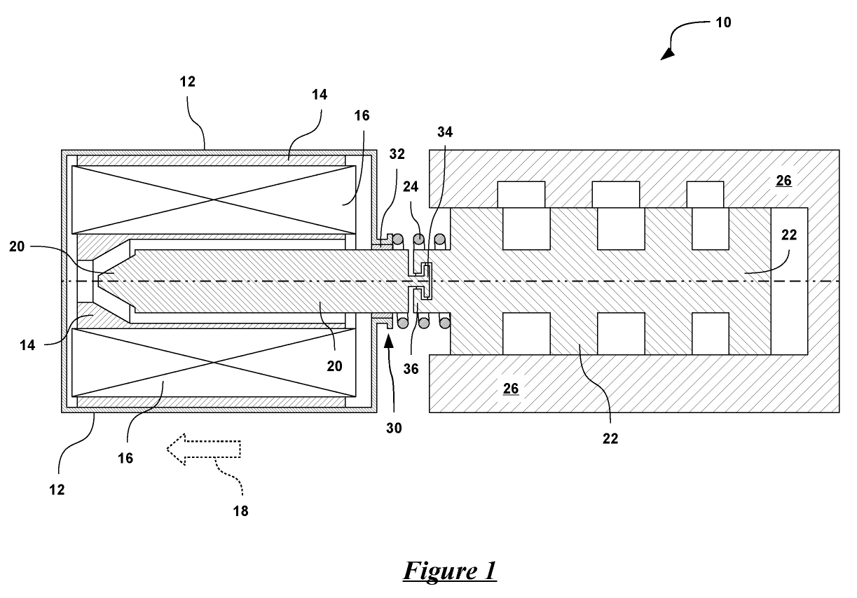

Referring to the drawings, wherein like reference numbers correspond to like or similar components throughout the several figures, there is shown in FIG. 1 a schematic, cross-sectional view of a solenoid valve 10. A housing 12 has a stator 14 statically disposed or mounted with respect to the housing 12.

The stator 14 includes a selectively energizable coil 16. Passing a current through the conductor material of the coil 16 establishes or generates a magnetic field within the coil 16. Magnetic materials located within the stator 14 would therefore direct the magnetic flux to the desired location when the coil 16 is selectively energized with such a current. In the view shown in FIG. 1, the magnetic field may impose either a rightward or leftward force on the armature portion 20, depending on the direction of the current through the coil 16. FIG. 1 schematically illustrates a resulting magnetic force as stator force 18, which is in the leftward direction.

An armature portion 20 is disposed annularly within the stator 14, and is therefore subject to the stator force 18 selectively created by the coil 16. The armature portion 20 is linearly moveable (to the left or right, as viewed in FIG. 1) within the stator 14.

The armature portion 20 is operatively connected (as described in more detail herein) to a spool portion 22, which is movably disposed within a valve body 26. As the armature portion 20 moves relative to the stator 14, the spool portion 22 therefore moves a substantially equal distance within the valve body 26. As the spool portion 22 moves within the valve body 26, operation of the solenoid valve 10 changes by variably blocking and opening fluid passages.

The valve body 26 may be attached by (for example, and without limitation) bolting, crimping, welding, or otherwise securing the valve directly to the housing 12. Alternatively, both the housing 12 and valve body 26 may be fixedly secured to other static structure, such that the stator 14 remains fixed with respect to the valve body 26.

The armature portion 20 is formed from a magnetic material capable of actuation by the magnetic field established by coil 16. The spool portion 22 may be formed from either a magnetic or nonmagnetic material suitable for use within valves, as would be recognized by those having ordinary skill in the art.

A return spring 24 is configured to provide a return force generally opposite the stator force 18. Therefore, as shown in FIG. 1, the return spring 24 is disposed between the housing 12 and spool portion 22, and is configured to bias the spool portion 22 to the right. When coil 16 is not energized, the return spring 24 moves the spool portion 22 to the right, which establishes the default position of solenoid valve 10. The default position may represent either an on, off, or partial-flow state for the solenoid valve 10.

In FIG. 1, much of the armature portion 20 is shown within the housing 12, and may, therefore, represent the leftward boundary of the range of movement available to armature portion 20. The position shown in FIG. 1 occurs when the coil 16 is energized and is pulling the armature portion 20 into the housing 12. Those having ordinary skill in the art will recognize that leftward movement of the armature portion 20 causes the return spring 24 to be compressed, which increases the magnitude of the return force acting upon the spool portion 22.

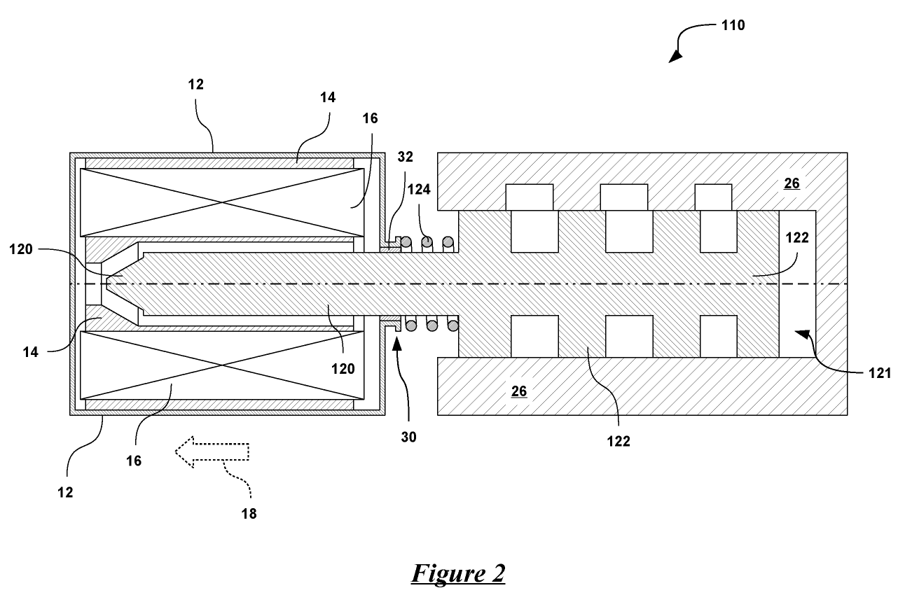

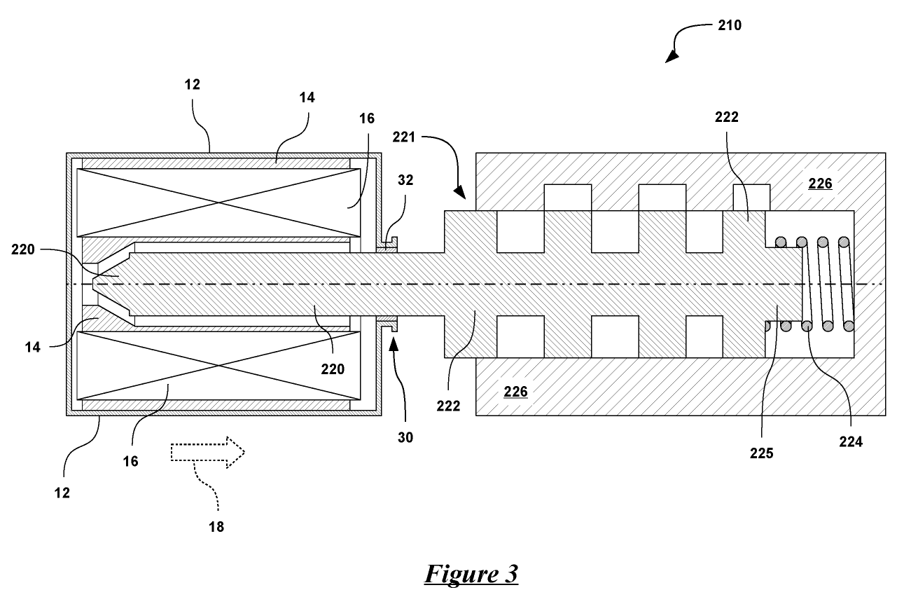

The solenoid valve 10 shown in FIG. 1 (and also those shown in FIGS. 2 and 3) may not be drawn to scale, and those having ordinary skill in the art will recognize that the gap between the exterior of the armature portion 20 and interior of the stator 14 may be smaller and may vary in geometry from what is shown in FIG. 1. Because the stator 14 shown in FIG. 1 is configured to produce the leftward stator force 18, the armature portion 20 is pulled toward, or into, the stator 14 when the coil 16 is energized. Pulling the armature portion 20 decreases the relative distance between the stator 14 and armature 20, which may increase the magnitude of the magnetic stator force 18 and counteract the increasing force occurring from compression of the return spring 24 and pushing the armature portion 20 rightward. Furthermore, the change of magnetic force can vary depending on the design and range of motion.

Due to tight tolerances between the stator 14 and armature portion 20, the solenoid valve 10 includes a piloting feature 30 which is operatively connected to the housing 12. The piloting feature is configured to align and guide the armature portion 20 as it moves or oscillates within the stator 14. The piloting features 30 may also help align and guide the armature portion 20 as it is assembled or joined to the housing 12 and stator 14.

The piloting feature 30 may therefore increase the ease of assembling the solenoid valve 10. As shown in FIG. 1, the piloting feature 30 may include a bushing 32 disposed annularly about an interface between the housing 12 and armature portion 20. The bushing 32 further assists in aligning and guiding assembly and movement of the armature portion 20. Misalignment of the armature portion 20 within the stator 14 may cause cocking or binding of the armature portion 20 and prevent proper operation of the solenoid valve 10.

The armature portion 20 further includes a first mating feature 34 on the end adjacent to the spool portion 22. The spool portion 22 further includes a second mating feature 36, which is configured to mate with, or be joinable to, the first mating feature 34. When the first and second mating features 34, 36 are attached, the armature portion 20 and spool portion 22 move together. Note that without the first and second mating features 34, 36, the return spring 24 would separate the spool portion 22 from the armature portion 20 as the stator 14 pulls the armature portion 20 leftward toward the housing 12 and the return spring 24 pushes the spool portion 22 rightward toward the valve body 26.

The first mating feature 34 may be, for example, and without limitation: a threaded end, a keyed end, a tongue end, or another suitable mating feature recognizable to those having ordinary skill in the art. Similarly, the second mating feature 36 may be, for example, and without limitation: a threaded receptacle, a key slot, a groove, or another suitable mating feature recognizable to those having ordinary skill in the art and corresponding to the specific first mating feature 34.

The first and second mating features 34, 36 may also be configured to allow for slight misalignment of the axis or the armature portion 20 relative to the axis of the spool portion 22, which may allow some flex (or slop) between the first and second mating features 34, 36. Otherwise, differences between the respective axes of the armature portion 20 and spool portion 22 may cause cocking or binding of the armature portion 20 within the stator 14 as well as the spool portion 22 within the valve body 26.

Referring now to FIG. 2, and with continued reference to FIG. 1, there is shown a solenoid valve 110, which is configured as a pull-style solenoid valve. The coil 16 generates stator force 18, which pulls an armature portion 120 leftward (as viewed in FIG. 2) toward the stator 14 and coil 16.

The return spring 24 provides an opposing force by pushing a spool portion 122 rightward. In both of the pull-style solenoid valves 10 and 110, the spool portions 22, 122 are disposed on the opposite side of the return springs 24, 124 from the stators 14. The piloting feature 30 of solenoid valve 110 also includes bushing 32 disposed annularly about the interface between the housing 12 and the armature portion 120.

The armature portion 120 is integrally formed with the spool portion 122. The armature and spool portions 120, 122 are part of a one-piece, combined armature-valve component 121. The combined armature-valve component 121 oscillates within the stator 14 and valve body 26 similar to the armature portion 20 and spool portion 22 of FIG. 1. However, combined armature-valve component 121 does not include first and second mating features 34, 36. Because the combined armature-valve component 121 includes both the armature and spool portions 120, 122, the spool portion 122 of solenoid valve 110 is also formed from a magnetic material.

Referring now to FIG. 3, and with continued reference to FIGS. 1-2, there is shown a solenoid valve 210, which is configured as a push-style solenoid valve. Unlike the solenoid valves 10 and 110 shown in FIGS. 1 and 2, the coil 16 is configured to generate a stator force 18 in the opposing direction. Stator force 18 applies a rightward force (as viewed in FIG. 3), and pushes an armature portion 220 away from the stator 14 and coil 16.

The return spring 224 still provides an opposing force, but the return spring 224 of solenoid valve 210 is disposed between a valve body 226 and a spool portion 222. A boss 225 may be provided on the spool portion 222 to align and center the return spring 224. Therefore, the return spring 224 increases the amount of force opposing movement of the spool portion 222 as the spool portion 222 is pushed into the valve body 226. Conversely, the stator force 18 may be decreasing in magnitude as the armature portion 220 moves away from the stator 14.

The armature portion 220 is integrally formed with the spool portion 222. The armature and spool portions 220, 222 are part of a one-piece, combined armature-valve component 221. The combined armature-valve component 221 oscillates within the stator 14 and valve body 226 similar to the combined armature-valve component 121 of FIG. 2, and also does not include first and second mating features 34, 36. Because the combined armature-valve component 221 includes both the armature and spool portions 220, 222, the spool portion 222 of solenoid valve 210 is also formed from a magnetic material.

Those having ordinary skill in the art will recognize that terms such as “above,” “below,” “upward,” “downward,” et cetera, are used descriptively of the figures, and do not represent limitations on the scope of the invention, as defined by the appended claims. While the best modes and other embodiments for carrying out the claimed invention have been described in detail, those familiar with the art to which this invention relates will recognize various alternative designs and embodiments for practicing the invention within the scope of the appended claims.

1. A solenoid valve, comprising:
an armature portion;
a spool portion;
a housing;
a piloting feature operatively connected to the housing and configured to align and guide the armature portion;
a stator disposed with respect to the housing and having a selectively energizable coil disposed annularly about the armature portion, wherein the stator is configured to selectively subject the armature portion to a stator force and the armature portion is linearly moveable within the stator; and
a return spring configured to provide a return force generally opposite the stator force.

2. The solenoid valve of claim 1, wherein the stator is configured such that the stator force pulls the armature portion toward the stator, and the return spring is configured to push the armature portion away from the stator.

3. The solenoid valve of claim 2, wherein the armature portion further includes a first mating feature and the spool portion further includes a second mating feature, and wherein the armature portion and the spool portion are each separate components which are operatively connected by the first and second mating features.

4. The solenoid valve of claim 3, wherein the spool portion is disposed opposite the return spring from the stator.

5. The solenoid valve of claim 4, wherein the piloting feature includes a bushing disposed annularly about an interface between the housing and the armature portion.

6. The solenoid valve of claim 2, wherein the armature portion and the spool portion are part of a one-piece, combined armature-valve component.

7. The solenoid valve of claim 6, wherein the spool portion is formed from a magnetic material.

8. The solenoid valve of claim 7, wherein the piloting feature includes a bushing disposed annularly about an interface between the housing and the armature portion.

9. The solenoid valve of claim 8, wherein the spool portion is disposed opposite the return spring from the stator.

10. The solenoid valve of claim 1, wherein the stator is configured such that the stator force pushes the armature portion away from the stator, and the return spring is configured to push the armature portion toward the stator.

11. The solenoid valve of claim 10, wherein the armature portion and the spool portion are part of a one-piece, combined armature-valve component.

12. The solenoid valve of claim 11, wherein the piloting feature includes a bushing disposed annularly about an interface between the housing and the armature portion.

13. The solenoid valve of claim 12, wherein the spool portion is formed from a magnetic material.

14. A solenoid valve, comprising:
an armature portion;
a spool portion;
a housing;
a piloting feature operatively connected to the housing and configured to align and guide the armature portion;
a stator disposed with respect to the housing and having a selectively energizable coil disposed annularly about the armature portion, wherein the stator is configured to selectively subject the armature portion to a stator force and the armature portion is linearly moveable within the stator; and
a return spring disposed between the stator and the spool portion, wherein said return spring is configured to provide a return force generally opposite the stator force.

15. The solenoid valve of claim 14, wherein the stator is configured such that the stator force pulls the armature portion toward the stator, and the return spring is configured to push the armature portion away from the stator.

16. The solenoid valve of claim 15, wherein the armature portion further includes a first mating feature and the spool portion further includes a second mating feature, and wherein the armature portion and the spool portion are each separate components which are operatively connected by the first and second mating features.

17. The solenoid valve of claim 15, wherein the armature portion and the spool portion are part of a one-piece, combined armature-valve component, and the combined armature-valve component is formed from a magnetic material.
